(19) United States
(12) Patent Application Publication
(10) Pub. No.: US 2015/0338079 A1
(43) Pub. Date: Nov. 26, 2015

(54) LIGHTING DEVICE WITH AT LEAST ONE SEMICONDUCTOR LIGHT SOURCE

(71) Applicant: OSRAM GMBH, München (DE)

(72) Inventors: Thomas PREUSCHL, Sinzing (DE); Peter SACHSENWEGER, Zeitlarn (DE)

(21) Appl. No.: 14/435,758

(22) PCT Filed: Sep. 24, 2013
(86) PCT No.: PCT/EP2013/069884

§ 371 Date: Apr. 15, 2015

(30) Foreign Application Priority Data
Oct. 19, 2012 (DE) 10 2012 219 144.5

(51) Int. Cl. F21V 23/06; F21V 15/01; H05B 33/08

(52) U.S. Cl. CPC F21V 23/06; H05B 33/0845; F21V 15/01; F21Y 2101/02

(57) ABSTRACT

Various embodiments may relate to a lighting device including a housing or a housing shell and at least one semiconductor light source. The semiconductor light source respectively includes at least one cathode connection and at least one anode connection, and the at least one cathode connection and the at least one anode connection are arranged together with the semiconductor light source on a light source carrier. At least respectively one electrical connection element for coupling the at least one cathode connection and the at least one corresponding anode connection to at least one driver device is arranged inside the housing or the housing shell. A first end of the respective connection element bears on the cathode connection or anode connection, respectively, and the second ends of the connection element, opposite the first ends, form the external connection of the lighting device.

### RELATED APPLICATIONS

The present application is a national stage entry according to 35 U.S.C. §371 of PCT application No.: PCT/EP2013/069884 filed on Sep. 24, 2013, which claims priority from German application No.: 102012219144.5 filed on Oct. 19, 2012, and is incorporated herein by reference in its entirety.

### TECHNICAL FIELD

Various embodiments relate to a lighting device having a housing or a housing shell and at least one semiconductor light source, wherein the semiconductor light source respectively includes at least one cathode connection and anode connection, and these are arranged with the semiconductor light source on a light source carrier. Light source carriers are intended to mean so-called submounts.

### BACKGROUND

A multiplicity of lighting devices of the species are known from the related art. For example, DE 10 2007 059 133 A1 describes an LED light source having at least one LED submount, the LED submount being arranged on a printed circuit board. The substrate adapted for use with the LED submount includes a plurality of fitting locations for light-emitting diodes as well as a plurality of pairs of, respectively, an electrical anode connection and cathode connection. This provides advantageous spatial separation between anode-side connections and cathode-side connections, together with a compact design even with a sizeable number of fitting locations. However, this entails a fundamental problem, which also occurs in other known lighting devices with semiconductor light sources. Specifically, known submount solutions have previously been elaborate in other substrate solutions, for example a connection installed between a submount and a printed circuit board. In this case, additional wiring is usually required. Moreover, additional adhesive bonding processes or mechanical connection processes are involved during production of the lighting devices for connection of the submount to the other substrate, in particular a printed circuit board. Furthermore, such known connection solutions do not correspond to the Zhaga industry standard.

### SUMMARY

Various embodiments provide a lighting device of the species so that simpler and more economical production of the lighting device can be achieved.

A lighting device according to various embodiments includes a housing or a housing shell and at least one semiconductor light source, wherein the semiconductor light source respectively includes at least one cathode connection and anode connection. The cathode and anode connections and also the semiconductor light source are arranged in this case on a light source carrier, namely a so-called submount. Furthermore, at least respectively one electrical connection element for coupling the at least one cathode connection and the at least one corresponding anode connection to at least one driver device is arranged inside the housing or the housing shell. The driver device here provides the electricity supply of the semiconductor light source. Furthermore, a first end of the respective connection element bears on the cathode or anode connection, the second ends of the connection elements, opposite the first ends, forming the external connection of the lighting device. By arrangement of the electrical connection elements inside the housing or the housing shell of the lighting device, an additional printed circuit board, to which the submount of the lighting device is connected, can be avoided. Additional wiring between these elements is therefore avoided. Furthermore, adhesive bonding processes do not need to be carried out between the light source carrier and the other substrates. Mechanical connection processes are also avoided. By the positioning according to various embodiments of the electrical connection elements on the cathode and anode connections of the semiconductor light source, further electrical connection elements are furthermore avoided, so that the resulting lighting device according to the invention can be produced simply and economically.

In another configuration of the lighting device according to various embodiments, the second ends of the connection elements are arranged ending in at least one opening of the housing or the housing shell. This leads to a kind of connection bush in which a corresponding plug solution can engage. The configuration of the plug is in this case dependent on the shape of the opening or bush and of the corresponding connection elements.

In another configuration of the lighting device according to various embodiments, the driver device is arranged outside the housing or the housing shell. This provides the possibility that a plurality of lighting devices according to various embodiments are coupled to one driver device.

In other configurations of the lighting devices according to various embodiments, the semiconductor light source includes at least one light-emitting diode, which is configured as an LED module, or in other words as an LED arrangement having a light-emitting diode chip or a plurality of light-emitting diode chips. Other configuration possibilities may also be envisioned. In particular, configuration of the semiconductor light source as an LED module or arrangement, i.e. as an arrangement of light-emitting diodes on a carrier or in a housing, allows simple and economical assembly of the lighting device according to various embodiments.

In other configurations of the lighting device, the first ends of the respective connection elements are arranged between the light source carrier and the housing shell or between the light source carrier and a housing cover of the housing. By such a configuration of the lighting device, it is possible for the surface of the light source carrier on the other side from the semiconductor light source to be able to be used in its entirety for cooling the lighting device. In particular, at least one active or passive cooling element may be arranged on this surface. Furthermore, the housing or the housing shell may include at least one projection or web, on which the connection elements at least partially bear and/or are supported. This leads to defined guiding of the connection elements inside the housing or the housing shell. In this way, for example, it is possible to form a web which is formed around a recess for the light of the semiconductor light source to pass through.

In other configurations of the lighting device according to various embodiments, the electrical connection elements are configured as electrical cable lines and/or as flat electrically conductive elements. Other electrically conductive elements may also be envisioned. In particular, flat electrically conductive elements which are configured as lead frames may be used here. The production of lead frames is economical and moreover also allows variants of the connection elements with a larger number of poles. Furthermore, it is possible for the first ends of the electrical connection elements to be configured in such a way that they exert a spring force on the respective cathode or anode connection. In this way, particularly reliable contacting between the electrical connection elements and said contacts is ensured.

Arrangement of at least one active or passive cooling element on said surface of the light source carrier furthermore has the advantage that only one thermal junction needs to be formed between the light source carrier and the cooling element. Since the entire surface of the light source carrier is available for contacting with the cooling element or elements, a higher application force on the heat sink is also advantageously obtained. This ensures excellent cooling of the lighting device according to various embodiments.

In other configurations of the lighting device according to various embodiments, the light source carrier or submount is mechanically connected to the housing or the housing shell by at least one fastening element arranged on the housing or the housing shell, wherein the fastening element engages in a corresponding opening of the light source carrier and/or latches therein. Inter alia, screws or press-fit pins are in this case used as fastening elements. Other connection elements may also be used. Furthermore, the fastening element or elements may be arranged in such a way that predefined position determination of the light source carrier relative to the housing or the housing shell is made possible. Furthermore, the housing or the housing shell may be configured overall in such a way that the specifications of the Zhaga standard are complied with (i.e. ZHAGA-compliantly). This advantageously also makes it possible to use the lighting device according to various embodiments in conjunction with product ranges of a wide variety of lighting device manufacturers.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a schematic representation of a lighting device according to the disclosure according to a first exemplary embodiment;

FIG. 2 shows a schematically represented view from below of the lighting device according to the disclosure according to FIG. 1;

FIG. 3 shows a schematically represented view from below of the lighting device according to the disclosure according to FIG. 1 without a light source carrier;

FIG. 4 shows a schematically represented view from below of a lighting device according to the disclosure according to a second exemplary embodiment; and

FIG. 5 shows a schematic sectional representation of a connection between a light source carrier and a housing shell of the lighting device according to the disclosure.

### DETAILED DESCRIPTION

The following detailed description refers to the accompanying drawing that show, by way of illustration, specific details and embodiments in which the disclosure may be practiced.

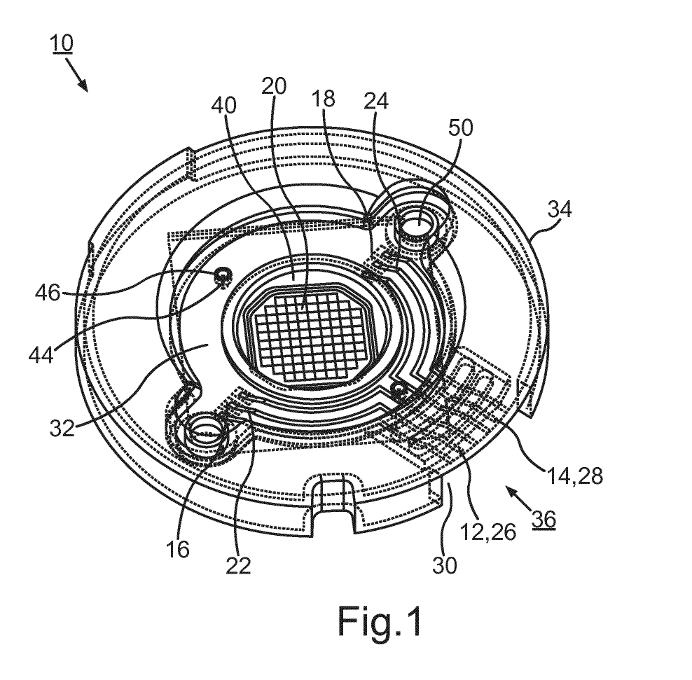

FIG. 1 shows a schematic representation of a lighting device 10 according to a first exemplary embodiment. The lighting device 10 here includes a housing shell 34 and a semiconductor light source 20. For better visibility of the light source carrier 32, the housing shell 34 is represented transparently in FIG. 1. In the embodiment represented, the semiconductor light source 20 is configured as an LED module having a plurality of light-emitting diode chips. The lighting device 10 furthermore includes a light source carrier 32. It can be seen that the semiconductor light source 20 is arranged on the light source carrier 32, a recess 40 in the housing shell 34 allowing the light to pass through. Cathode connections 16 and corresponding anode connections 18 of the semiconductor light source 20 are furthermore formed on the light source carrier 32, also referred to as a submount. Further electronic components may also be arranged in or on the light source carrier 32. The light source carrier 32 in the embodiment represented is fastened by two fastening elements 44, which are formed in the manner of pins and latch in a corresponding opening 46 of the light source carrier 32.

It can furthermore be seen that a plurality of electrical connection elements 12, 14 for coupling the cathode connections 16 and the corresponding anode connections 18 to at least one driver device (not represented) are arranged inside the housing shell 34. The driver device regulates the electricity supply of the lighting device. The respective connection elements 12, 14 respectively have a first end 22, 24 and a second end 26, 28 in this case. The first end 22, 24 bears on the cathode or anode connection 16, 18, and the opposite second ends 26, 28 form an external connection 36 of the lighting device 10. In the exemplary embodiment represented, the second ends 26, 28 are arranged ending in an opening or recess 30 of the housing shell 34, and form a kind of connection bush 36. In total, six electrical connection elements 12, 14 are represented in the exemplary embodiment represented. Other embodiments, which are respectively aimed at the design and construction requirements of the respective lighting device, may also be envisioned.

Furthermore, in the embodiment represented, the electrical connection elements 12, 14 are configured as flat electrically conductive elements 42, in particular made of metal or a metal alloy. It is, however, also possible for other types of electrical connection elements, for example electrical cable lines, to be used. The electrical connection elements 12, 14 represented are configured as lead frames and may, according to the respective requirements, includes a corresponding number of connection lines, in order for example also to cover variants with a larger number of poles.

The lighting device 10 represented furthermore has two housing openings 50 which are used for fastening the lighting device 10 to at least one heat sink (not represented) and/or another fastening surface, for example a wall or ceiling. Fastening is in this case carried out by corresponding fastening elements such as screws, pins or the like.

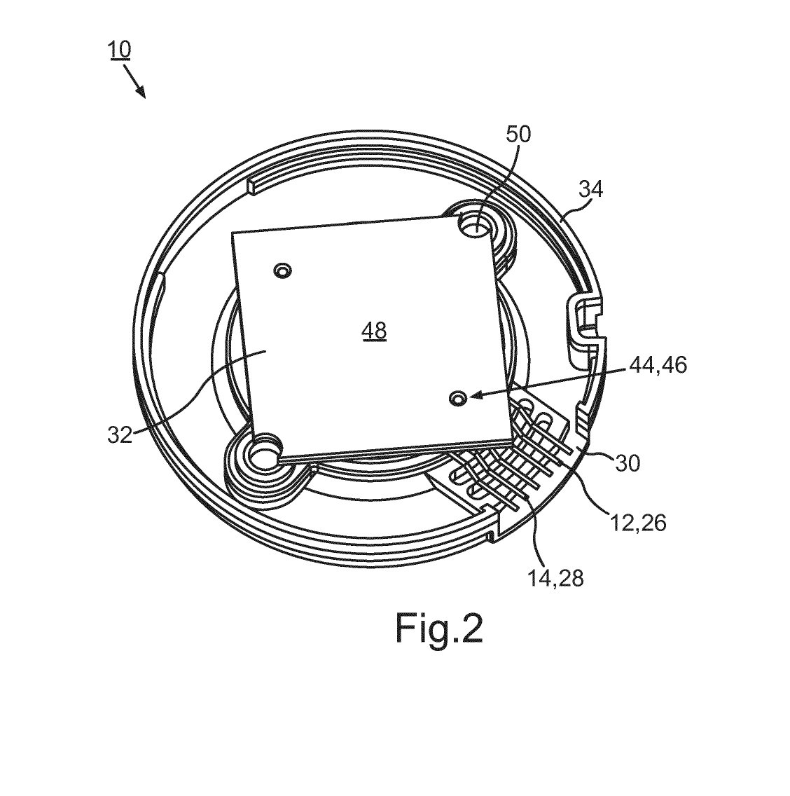

FIG. 2 shows a schematically represented view from below of the lighting device 10 according to FIG. 1. The arrangement of the light source carrier or submount 32 on the housing shell 34 can be seen. The fastening pins 44 of the housing shell 34 engage here in corresponding openings 46 of the light source carrier 32 and latch therein. The light source carrier 32 furthermore includes corresponding recesses which correspond with the openings 50 in the housing shell 34.

At least one active or passive cooling element is conventionally arranged on the surface 48 of the light source carrier 32.

It can furthermore be seen that, in the exemplary embodiment represented, the first ends 22, 24 of the respective connection elements 12, 14 at least partially extend and are arranged between the light source carrier 32 and the housing shell 34.

The second ends 26, 28 of the connection elements 12, 14 are accessible from outside the housing shell 34 and end in the opening 30 of the housing shell 34. In the embodiment represented, those subsections of the connection elements 12, 14 which lie next to the ends 26, 28 are configured with an angle and at least partially bear on a support formed in the opening 30.

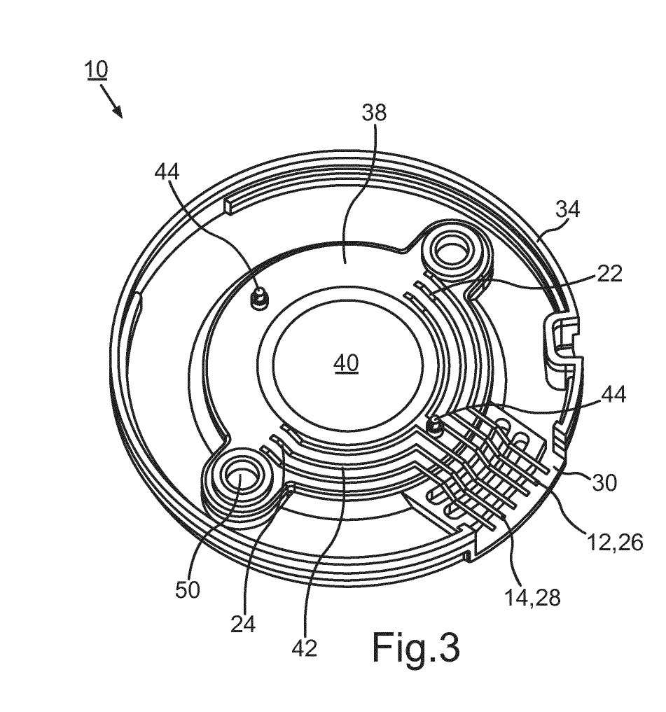

FIG. 3 shows a schematically represented view from below of the lighting device 10 according to FIG. 1 without a light source carrier 32. It can be seen here that the first ends 22, 24 of the connection elements 12, 14 are likewise configured with a bend or angle. This leads to a spring effect of the first ends 22, 24, which press with a spring force on the corresponding contacts of the light source carrier 32. It can furthermore be seen that the electrical connection elements 12, 14 configured as flat elements 42 bear at least partially on an approximately circularly configured web 38 inside the housing shell 34 and are supported there. The web 38 in this case is formed around the recess 40 for the light of the semiconductor light source 20 to pass through. In the embodiment represented, the first ends 22, 24 of the connection elements 12, 14 reach approximately as far as the middle of the circumference of the web 38.

It can furthermore be seen that, in the embodiment represented, two fastening elements 44, namely two fastening pins or bolts, are formed in the housing shell 34. The connection between the housing shell 34 and the light source carrier 32 is carried out by these fastening elements 44, which latch in corresponding openings 46 of the light source carrier 32. The connection may in this case be configured releasably or irreleasably.

In particular, the arrangement of the fastening elements 44 on the housing shell 34 serves for predefined position determination of the light source carrier 32 relative to the housing shell 34.

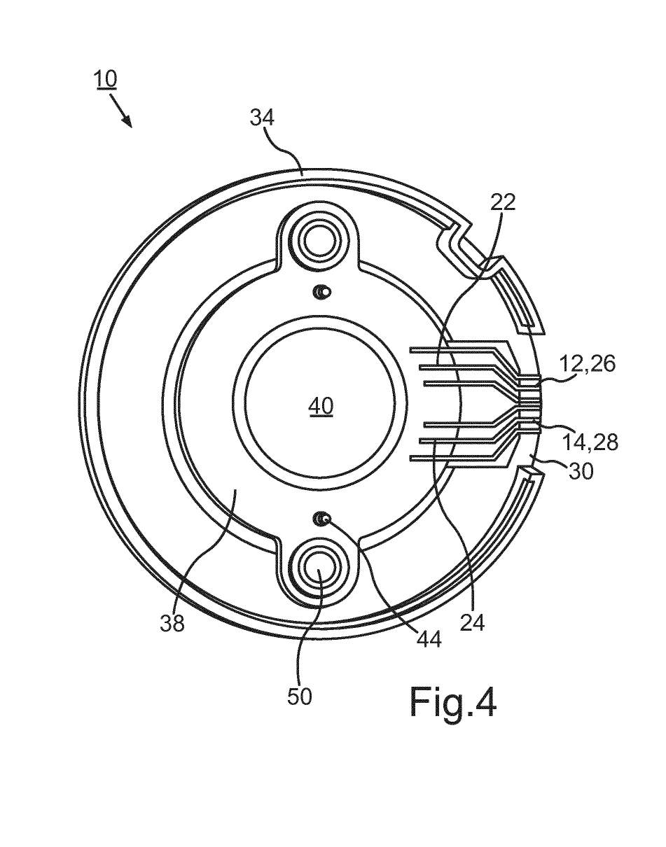

FIG. 4 shows a schematically represented view from below of a lighting device 10 according to a second embodiment. For better representability, the second embodiment of the lighting device is represented without a light source carrier 32. The configuration of the electrical connection elements 12, 14, which is different to that in the first embodiment represented in FIGS. 1 to 3, can be seen. Although the second ends 26, 28 are again arranged in the opening 30 of the housing shell 34, the first ends 22, 24 already end in a region at a short distance behind the opening 30. The first ends 22, 24 again bear here on the circular web 38. In the second embodiment as well, the electrical connection elements 12, 14 are configured as flat electrically conductive elements 42, in particular made of metal or a metal alloy, and it is clear that the configuration of the electrical connection elements 12, 14 may readily be adapted to the respective requirements. In particular, different positions of the contact connections on the light source carrier or submount 32 may be envisioned here.

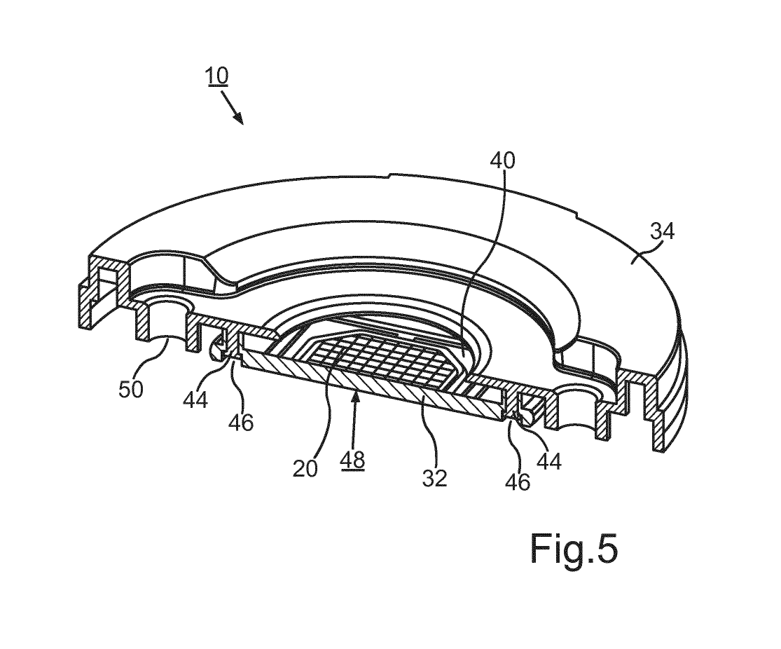

FIG. 5 shows a schematic sectional representation of a connection between the light source carrier 32 and the housing shell 34 of the lighting device 10. It can be seen that the fastening elements 44 arranged in the housing shell 34 are configured in the form of bolts or pins, the ends of these fastening elements 44 having a thickening which latches with a circumferential collar or projections formed in the openings 46 of the light source carrier 32. FIG. 5 furthermore shows the arrangement of the semiconductor light source 20 and of the light exit opening 40 inside the housing shell 34.

Overall, the housing shell 34, or the lighting device 10, may be configured in such a way that they correspond to the specifications of the Zhaga standard. The avoidance of additional printed circuit boards, for example, which is possible by virtue of the new configuration of the lighting device 10, makes it easier to fulfill the design requirements of the Zhaga standard.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A lighting device comprising: a housing or a housing shell and at least one semiconductor light source, wherein the semiconductor light source respectively comprises at least one cathode connection and at least one anode connection, and the at least one cathode connection and the at least one anode connection are arranged together with the semiconductor light source on a light source carrier, wherein at least respectively one electrical connection element for coupling the at least one cathode connection and the at least one corresponding anode connection to at least one driver device is arranged inside the housing or the housing shell, wherein a first end of the respective connection element bears on the cathode connection or anode connection, respectively, and the second ends of the connection elements, opposite the first ends, form the external connection of the lighting device.

2. The lighting device as claimed in claim 1, wherein the second ends of the connection elements are arranged ending in at least one opening of the housing or the housing shell.

3. The lighting device as claimed in claim 1, wherein the driver device is arranged outside the housing or the housing shell.

4. The lighting device as claimed in claim 1, wherein the semiconductor light source comprises at least one light-emitting diode.

5. The lighting device as claimed in claim 1, wherein the semiconductor light source is configured as an LED module having a light-emitting diode chip or a plurality of light-emitting diode chips.

6. The lighting device as claimed in claim 1, wherein the first ends of the respective connection elements are arranged between the light source carrier and the housing shell or between the light source carrier and a housing cover of the housing.

7. The lighting device as claimed in claim 1, wherein the housing or the housing shell comprises at least one projection or web, on which the connection elements at least partially bear and/or are supported.

8. The lighting device as claimed in claim 7, wherein the web is formed around a recess for the light of the semiconductor light source to pass through.

9. The lighting device as claimed in claim 1, wherein the electrical connection elements are configured as electrical cable lines and/or as flat electrically conductive elements.

10. The lighting device as claimed in claim 9, wherein the flat electrically conductive elements are configured as lead frames.

11. The lighting device as claimed in claim 1, wherein the first ends of the electrical connection elements are configured in such a way that they exert a spring force on the respective cathode or anode connection.

12. The lighting device as claimed in claim 1, wherein the light source carrier is mechanically connected to the housing or the housing shell by at least one fastening element arranged on the housing or the housing shell, wherein the fastening element engages in a corresponding opening of the light source carrier and/or latches therein.

13. The lighting device as claimed in claim 12, wherein the fastening element or elements are arranged in such a way that predefined position determination of the light source carrier relative to the housing or the housing shell is made possible.

14. The lighting device as claimed in claim 1, wherein at least one active or passive cooling element is arranged on the opposite surface of the light source carrier from the semiconductor light source.

15. The lighting device as claimed in claim 1, wherein the housing or the housing shell is configured ZHAGA-compliantly.
